(19) United States
(12) Patent Application Publication
(10) Pub. No.: US 2015/0159644 A1
(43) Pub. Date: Jun. 11, 2015

(54) Device and Method for Operating A Fuel Feed System and Fuel Feed System

(71) Applicants: Stephan Jonas, Schwalbach (DE); Jochen Burgdorf, Offenbach am Main (DE)

(72) Inventors: Stephan Jonas, Schwalbach (DE); Jochen Burgdorf, Offenbach am Main (DE)

(73) Assignee: CONTINENTAL AUTOMOTIVE GMBH, Hannover (DE)

(21) Appl. No.: 14/359,964

(22) PCT Filed: Nov. 22, 2012
(86) PCT No.: PCT/EP2012/073299

§ 371 Date: Oct. 21, 2014

(30) Foreign Application Priority Data
Nov. 24, 2011 (DE) 10-2011-087-041.5

(51) Int. Cl. F04B 49/08; F04B 17/03; F02M 59/02

(52) U.S. Cl. CPC F04B 49/08; F02M 59/022; F04B 17/03

(57) ABSTRACT

A device for operating a fuel feed system having an electric pump, arranged within a fuel tank, in order to convey fuel from the fuel tank to a fuel accumulator, is configured to perform closed-loop or open-loop control of the rotational speed of the electric pump as a function of a predefined value for a pressure in the fuel accumulator.

### CROSS-REFERENCE TO RELATED APPLICATIONS

This application is a U.S. National Stage Application of International Application No. PCT/EP2012/073299 filed Nov. 22, 2012, which designates the United States of America, and claims priority to DE Application No. 10 2011 087 041.5 filed Nov. 24, 2011, the contents of which are hereby incorporated by reference in their entirety.

### TECHNICAL FIELD

The invention relates to a device and a method for operating a fuel feed system. The invention also relates to a fuel feed system, in particular for a motor vehicle.

### BACKGROUND

Conventional high-pressure gasoline injection systems have a pump which is driven by an electric motor and which is arranged in the gasoline tank. This electric pump is provided in addition to the high pressure pump which is mounted on the internal combustion engine and driven by the cam shaft. The electric pump is configured to make available a pressure of approximately 5 bar in such a system. The high pressure up to approximately 200 bar is implemented by the pump which is mounted on the internal combustion engine and driven by the cam shaft. In this context, an active volume-regulating valve or pressure-regulating valve must be provided, which regulates the pressure which is made available to the injection valves.

### SUMMARY

One embodiment provides a device for operating a fuel feed system having an electric pump which is arranged inside a fuel tank in order to feed fuel from the fuel tank to a fuel accumulator, wherein the device is configured to perform closed-loop or open-loop control of the rotational speed of the electric pump as a function of a predefined value for a pressure in the fuel accumulator.

In a further embodiment, the device is configured to regulate the electric pump as a function of a difference between a determined actual pressure in the fuel accumulator and the predefined value for the pressure.

In a further embodiment, the device is configured to determine a current value for the electric pump as a function of the predefined pressure, and to control the electric pump by means of the determined value of the electrical current for the electric pump.

In a further embodiment, the device is configured to determine an estimated value for the pressure in the fuel accumulator as a function of a determined value of the electrical current at the electric pump and a determined value of the electrical voltage at the electric pump, and to regulate of the electric pump as a function of a difference between the determined estimated value for the pressure and the predefined value for the pressure.

Another embodiment provides a fuel feed system, comprising a fuel tank, an electric pump with closed-loop or open-loop control of its rotational speed, which electric pump is arranged inside the fuel tank in order to feed fuel from the fuel tank to a fuel accumulator, and a pressure accumulator which is in each case coupled hydraulically to the electric pump and to the fuel accumulator and which is arranged hydraulically between the electric pump and the fuel accumulator, wherein the pressure accumulator is arranged inside the fuel tank.

In a further embodiment, the fuel feed system comprises a device as disclosed above, which is coupled to the electric pump in order to perform closed-loop or open-loop control of the rotational speed of the electric pump.

In a further embodiment, the electric pump is configured to make available a pressure in the fuel accumulator of more than 100 bar.

Another embodiment provides a method for operating a fuel feed system having an electric pump which is arranged inside a fuel tank in order to feed fuel from the fuel tank to a fuel accumulator, comprising: performing closed-loop or open-loop control of a rotational speed of the electric pump as a function of a predefined value for a pressure in the fuel accumulator.

In a further embodiment, the method comprises: determining an actual pressure in the fuel accumulator, determining a difference between the determined actual pressure and the predefined value for the pressure, and regulating the rotational speed of the electric pump as a function of the determined difference.

In a further embodiment, the method comprises determining a current value for the electric pump as a function of the predefined pressure, and applying the determined current value to the electric pump and as a result controlling of the rotational speed of the electric pump.

In a further embodiment, the method comprises determining a value of the electrical current at the electric pump, determining a value of the electrical voltage at the electric pump, determining an estimated value for the pressure in the fuel accumulator as a function of the determined value of the current and the determined value of the voltage, and regulating the rotational speed of the electric pump as a function of the determined estimated value.

### BRIEF DESCRIPTION OF THE DRAWINGS

Examples embodiments of the invention are explained below in conjunction with the figures, in which:

FIG. 1 shows a schematic illustration of a fuel feed system according to one embodiment,

FIG. 2 shows a schematic illustration of a fuel feed system according to one embodiment, and

FIG. 3 shows a diagram of the dependencies during current control of the electric pump according to one embodiment.

### DETAILED DESCRIPTION

Embodiments of the present invention provide a device and a method for operating a fuel feed system which both permit simple closed-loop or open-loop control of the fuel feed system. In addition, some embodiments provide a fuel feed system for which closed-loop or open-loop control can be easily performed.

According to some embodiments, the fuel feed system has an electric pump which is arranged inside a fuel tank. The electric pump is configured to feed fuel from the fuel tank to a fuel accumulator. Closed-loop or open-loop control of the rotational speed of the electric pump is performed as a function of a predefined value for a pressure in the fuel accumulator.

Through the closed-loop or open-loop control of the rotational speed of the electric pump it is easily possible to regulate the quantity of the feeding by the electric pump. Electrical energy is fed to the electric pump as a function of the predefined value for the pressure in the fuel tank, and the rotational speed of the electric pump is therefore adjusted. The feed quantity and therefore the pressure which is made available are therefore easily adjusted.

The pump is, for example, a piston pump which has merely passive inlet and outlet valves. It is possible to dispense with active volume regulating valves or pressure regulating valves since the regulation of the volume flow is adjusted by means of the variable rotational speed of the electric pump. Therefore, all that is necessary is to make available a single pump in the fuel feed system which feeds the fuel from the fuel tank to the fuel accumulator. It is possible to dispense with a second pump which is driven by the cam shaft and is mounted, for example, on the internal combustion engine.

The electric pump is arranged in the fuel tank from which it can feed fuel. As a result, leakage can be tolerated. The electric pump is configured, in particular, to make available a pressure of up to 200 bar. In particular, the electric pump is configured to make available a pressure between 50 bar and 250 bar. The fuel pump is configured, for example, to make available a pressure in the fuel accumulator of more than 100 bar.

The electric pump, which can make available a high pressure, can be used to implement a cost-effective fuel feed system since only a single pump is provided to feed fuel from the tank and to make it available at high pressure in the fuel accumulator. In addition, there is no need for a volume flow valve. In addition, the drive of the electric pump can be easily cooled within the fuel tank.

According to embodiments, an actual pressure in the fuel tank is determined. A difference between the determined actual pressure and the predefined value for the pressure is determined. The rotational speed of the electric pump is regulated as a function of the determined difference.

For example, in order to determine the actual pressure in the fuel accumulator, a pressure sensor is arranged in the fuel accumulator. The pressure sensor is coupled to the device for operating the fuel system. The electric pump is fed more or less electrical energy as a function of the difference between the desired predefined value for the pressure and the current actual pressure in the fuel accumulator, with the result that the rotational speed of the electric pump and therefore the volume flow of the electric pump changes. The actual pressure is therefore easily adjusted to the predefined value for the pressure.

According to further embodiments, a current value for the electric pump is determined as a function of the predefined pressure. The determined current value is applied to the electric pump and as a result the rotational speed of the electric pump is controlled. It is therefore possible to dispense with the pressure sensor in the fuel accumulator. As a result, a cost-effective fuel feed system is possible. Pure current control of the electric pump is possible since the applied current is proportional to the rotational speed of the pump and the rotational speed of the pump is in turn proportional to the pressure which is made available. The pressure which is made available by the electric pump can therefore be controlled directly.

According to further embodiments, a value of the electrical current at the electric pump is determined. A value of the voltage at the electric pump is determined. An estimated value for the pressure in the fuel accumulator is determined as a function of the determined value of the current and the determined value of the voltage. The rotational speed of the electric pump is regulated as a function of the determined estimated value. As a result it is possible to dispense with the pressure sensor in the fuel accumulator. The estimated value for the current actual pressure in the fuel accumulator is determined from the current and the voltage at the electric pump. For example the rotational speed of the electric pump is regulated on the basis of a difference between the estimated actual pressure and the predefined value for the pressure, with the result that the actual pressure is adjusted to the predefined value for the pressure.

According to further embodiments, the fuel system has a pressure accumulator which is in each case coupled hydraulically to the electric pump and to the fuel accumulator and which is arranged hydraulically between the electric pump and the fuel accumulator. The pressure accumulator is arranged inside the fuel tank. The pressure accumulator is charged by the electric pump, with the result that, for example, the pump has to feed fuel actively only when the pressure accumulator is empty or approximately empty.

As a result, during operation the pump can already be operated continuously in the full feed mode, for example, but only for a fraction of the operating time of the engine. As a result, an efficient and wear-reducing operating mode is possible. The pressure accumulator stabilizes the regulation of the pressure for the fuel accumulator. In addition, in particular in the case of motor vehicles with a stop/start function, a pressure reserve is available during frequent switching off and on of the internal combustion engine. As a result of the arrangement of the pressure accumulator inside the fuel tank, simple design of the pressure accumulator is possible since leakage due to the principle can be implemented by the arrangement in the tank. The operating mode which is as efficient as possible permits, in particular, CO₂ reduction.

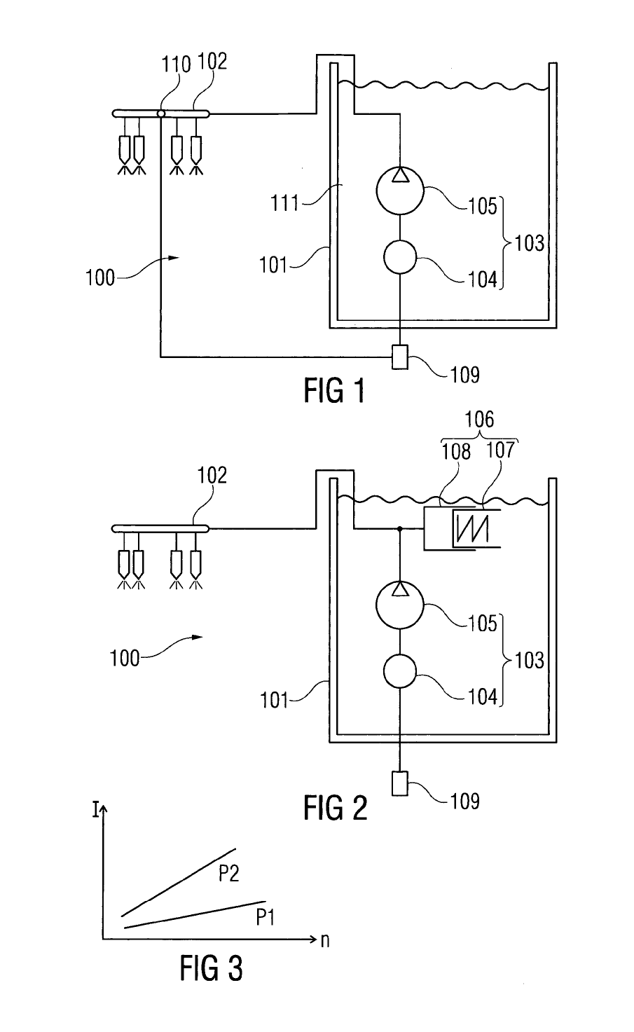

FIG. 1 shows a schematic illustration of a fuel feed system 100. The fuel feed system 100 has a fuel tank 101. A fuel, for example gasoline, is stored in the fuel tank 101.

The fuel feed system 100 also has an electric pump 103. The electric pump 103 is configured to feed fuel 111 from the fuel tank.

The fuel feed system 100 also has a fuel accumulator 102. The fuel accumulator 102 is arranged outside the fuel tank 101. The fuel accumulator 102 is coupled hydraulically to the electric pump 103.

The fuel accumulator 102 is filled during operation by the electric pump 103 with fuel 111 from the fuel tank 101. The fuel is fed from the fuel accumulator 102 to, for example, injectors, and is sprayed by the latter into combustion chambers of an internal combustion engine. The fuel pressure which is necessary for the fuel accumulator 102 is made available by the electric pump 103.

The fuel feed system 100 is arranged, in particular, in a motor vehicle and serves to feed fuel to a gasoline engine with direct injection.

The electric pump 103 has an electric motor 104 and a pump body 105. The electric motor 104 serves to drive the electric pump 103. For example, the electric pump 103 is a piston pump which has passive inlet and outlet valves. Depending on the embodiment, the electric motor can also be arranged outside the fuel tank or at least inside the tank (101) in such a way that it cannot enter into contact with the fuel, with the result that damage caused thereby to the motor (104) can be prevented.

The pump body 105 is coupled directly to the fuel accumulator 102 via fuel lines. No further pump is provided between the electric pump 103 and the fuel accumulator 102. The electric pump 103 is configured to make available a sufficiently high pressure in the fuel accumulator 102 which is required for the direct injection of gasoline. The electric pump 103 is configured to make available a fuel pressure of more than 50 bar, in particular a pressure of more than 100 bar and, in particular, a pressure of at least 200 bar.

The fuel feed system does not have any active volume regulating valves or pressure regulating valves. The pressure in the fuel accumulator 102 is adjusted by performing closed-loop or open-loop control of the rotational speed of the electric pump 103.

A device 109 is coupled to the fuel pump 103. The device 109 is configured to perform closed-loop or open-loop control of the rotational speed of the electric pump 103. The device 109 adjusts the rotational speed of the electric pump 103, in particular, as a function of a predefined pressure for the fuel accumulator 102. For example, the pressure for the fuel accumulator 102 is predefined as a function of an operating mode of the internal combustion engine. If the pressure in the fuel accumulator 102 is to be increased compared to a current pressure, the device 109 sets a relatively high rotational speed of the electric pump 103. For this purpose, for example, more electrical energy is fed to the electric pump 103. As a result, the volume flow of the electric pump 103 and therefore the pressure in the fuel accumulator 102 rise. Correspondingly, the rotational speed and therefore the volume flow of the electric pump 103 are reduced if a relatively low pressure is predefined in the fuel accumulator 102. The quantity of fuel which is fed to the fuel accumulator 102 from the electric pump 103 is adjusted by means of the rotational speed of the electric pump 103 and therefore by means of the electrical energy which is supplied.

According to various embodiments, a pressure sensor 110 is provided in the fuel accumulator 102. The pressure sensor 110 is configured to determine a current actual pressure of the fuel in the fuel accumulator 102. The pressure sensor 110 is coupled to the device 109. The pressure sensor 110 transmits the determined actual pressure to the device 109.

The device 109 is configured to compare the determined current actual pressure with the predefined value for the pressure in the fuel accumulator 102. If the determined actual pressure in the fuel accumulator 102 differs from the predefined value for the pressure, in particular by more than a predefined tolerance range, the device 109 correspondingly adjusts the electric pump 103. For example, the device 109 outputs a regulating signal which sets the rotational speed of the electric pump 103 as a function of the difference between the determined actual pressure and the predefined value for the pressure.

If the determined actual pressure is lower than the predefined value for the pressure, the rotational speed of the electric pump is increased by means of the device 109. If the determined actual pressure is higher than the predefined value for the pressure, the rotational speed of the electric pump 103 is reduced by the device 109. In particular, the device 109 outputs a regulating signal, with the result that the electric pump 103 is supplied with electrical energy as a function of the difference between the actual pressure and the predefined value for the pressure.

FIG. 2 shows a schematic illustration of the fuel feed system 100 in FIG. 1 according to further embodiments. In contrast to the embodiments in FIG. 1, the fuel system according to the embodiments in FIG. 2 does not have a pressure sensor 110. Furthermore, the fuel feed system 100 according to the embodiments in FIG. 2 has, in contrast to the embodiments in FIG. 1, a pressure accumulator 106. According to further embodiments, the pressure accumulator 106 is also provided in the embodiments in FIG. 1.

The pressure accumulator 106 is arranged inside the fuel tank 101. The pressure accumulator 106 is coupled hydraulically to the electric pump 103 and to the fuel accumulator 102. The pressure accumulator 106 is arranged downstream of the electric pump 103, hydraulically between the electric pump 103 and the fuel accumulator 102.

According to embodiments, the pressure accumulator 106 has an accumulator body 108 and a piston 107. The piston 107 is movably arranged in the accumulator body 108 and prestressed, for example by means of a spring. Fuel which is fed by the electric pump 103 passes into the pressure accumulator 106 and shifts the piston 107 relative to the accumulator body 108, counter to the spring force. Leakage of the pressure accumulator, in particular between the piston 107 and the accumulator body 108, can be tolerated since the pressure accumulator 106 is arranged in the fuel tank 101.

The pressure accumulator 106 is filled with fuel by the electric pump 103, while the electric pump 103 feeds fuel. If the electric pump 103 is switched off, or feeds less fuel than required, the pressure accumulator 106 outputs fuel to the fuel accumulator 102. It is therefore possible, even during a stationary state of the electric pump 103, to maintain the pressure in the fuel accumulator 102. As a result it is possible to allow the pump always to run in the full feed mode in order to fill the pressure accumulator 106, and to stop the electric pump 103 when the pressure accumulator 106 is full.

The pressurized fuel for the fuel accumulator 102 is then made available by the pressure accumulator 106. The electric pump 103 therefore runs only for a fraction of the operating time of the internal combustion engine, as a result of which the electric pump 103 can be operated efficiently and in a wear-reducing fashion. The pressure accumulator 106 additionally acts in a stabilizing fashion on the pressure in the fuel accumulator 102 and equalizes pressure fluctuations. In the case of motor vehicles with a stop/start function, a pressure reserve is available in the pressure accumulator 106.

According to embodiments, the rotational speed of the electric pump 103 is controlled directly by means of the applied current value for the electric pump without the pressure sensor 110.

As illustrated in FIG. 3, the torque of the electric pump 103 and also a rotational speed n of the electric pump 103 are proportional to an electrical current I which is applied to the electric pump 103. The torque or the rotational speed n of the electric pump 103 is proportional to the pressure which is made available by the electric pump 103. The ratio of the electrical current I to the rotational speed n is constant for the predefining pressure, for example for a pressure of P1=70 bar and a pressure of P2=120 bar.

It is therefore possible to determine, as a function of the predefined pressure, for example by means of predefined characteristic diagrams the current value, associated with the predefined pressure, for the electric pump. As a result, the pressure which the electric pump 103 generates can perform control by means of the device 109 directly using the electrical current. For example, a current value of 20 A is stored in the characteristic diagram for a predefined pressure of 100 bar. If the predefined pressure for the fuel accumulator 102 is, for example, 100 bar, the device 109 outputs a corresponding control signal with the result that a current of 20 A is applied to the electric pump 103. The rotational speed of the electric pump 103 is controlled by the applied current of 20 A in such a way that a pressure of approximately 100 bar builds up in the fuel accumulator 102.

According to further embodiments, the electric pump 103 is regulated by the device 109 without a pressure sensor 110 in that the device 109 determines a value of the electrical current at the electric pump. Furthermore, the device 109 determines a value of the electrical voltage at the electric pump 103. The device 109 is configured to determine an estimated value for the actual pressure in the fuel accumulator from the value of the electrical current and the value of the electrical voltage. The device 109 is configured to compare the determined estimated value for the actual pressure with the predefined value for the pressure in the fuel accumulator 102, in particular to form a difference. The rotational speed of the electric pump is regulated by the device 109 as a function of the determined estimated value, in particular as a function of the difference between the estimated value and the predefined value for the pressure.

The open-loop or closed-loop control of the electric pump 103 without the pressure sensor 110 is, as explained in conjunction with the embodiments in FIG. 2, also provided in further embodiments in which the fuel feed system 110 does not have a pressure accumulator 106.

As a result of the electric pump 103, which is configured to make available a pressure in the fuel accumulator 102 which is sufficient for gasoline direct injection, the fuel system is cost-effective since only a single pump is now necessary. As a result of the device 109, which is configured to perform closed-loop or open-loop control of the rotational speed of the electric pump with the result that a predefined volume flow is made available by the electric pump 103, simple closed-loop or open-loop control of the fuel feed system 100 is possible. In particular, no additional active volume flow valve or pressure regulating valve is necessary, as a result of which the fuel feed system 100 is cost-effective. As a result of the proportionality between the rotational speed of the electric pump, the pressure and the applied electrical current it is possible to dispense with the pressure sensor 110, as a result of which a cost-effective fuel feed system 100 is possible.

According to embodiments in which the fuel feed system 100 has the pressure accumulator 106, a fuel volume reserve is made available in the pressure accumulator 106 within the fuel tank 101. As a result, intermittent, efficient operation of the internal combustion engine and electric pump 103 is possible. This is advantageous in particular for motor vehicles with a stop/start device or with hybrid concepts. The electric motor 104 of the electric pump 103 is cooled relatively easily within the fuel tank 101. The electric motor 104 is used by the device 109 to perform open-loop or closed-loop control of the pressure in the fuel accumulator 102.

What is claimed is:

1. A device for operating a fuel feed system having an electric pump arranged inside a fuel tank to feed fuel from the fuel tank to a fuel accumulator,
wherein the device is configured to:
access a predefined value for a pressure in the fuel accumulator, and
perform closed-loop or open-loop control of the rotational speed of the electric pump as a function of the predefined value for a pressure in the fuel accumulator.

2. The device of claim 1, wherein the device is configured to:
determining a difference between a determined actual pressure in the fuel accumulator and the predefined value for the pressure, and
regulate the electric pump as a function of the difference between the determined actual pressure in the fuel accumulator and the predefined value for the pressure.

3. The device of claim 1, wherein the device is configured to:
to determine a current value for the electric pump as a function of the predefined pressure, and
to control the electric pump by means of the determined value of the electrical current for the electric pump.

4. The device of claim 1, wherein the device is configured to:
to determine an estimated value for the pressure in the fuel accumulator as a function of a determined value of the electrical current at the electric pump and a determined value of the electrical voltage at the electric pump, and
to regulate of the electric pump as a function of a difference between the determined estimated value for the pressure and the predefined value for the pressure.

5. A fuel feed system, comprising:
a fuel tank,
a device including an electric pump arranged inside the fuel tank to feed fuel from the fuel tank to a fuel accumulator, wherein the device is configured to control a rotational speed of the electric pump using closed-loop or open-loop control, and
a pressure accumulator hydraulically coupled to the electric pump and to the fuel accumulator, wherein the pressure accumulator is arranged hydraulically between the electric pump and the fuel accumulator, and arranged inside the fuel tank.

6. The fuel feed system of claim 5, comprising a device coupled to the electric pump and configured to perform closed-loop or open-loop control of the rotational speed of the electric pump as a function of a predefined value TOT a pressure in the fuel accumulator.

7. The fuel feed system of claim 5, wherein the electric pump is configured to make available produce a pressure in the fuel accumulator of more than 100 bar.

8. A method for operating a fuel feed system having an electric pump arranged inside a fuel tank to feed fuel from the fuel tank to a fuel accumulator, the method comprising:
accessing a predefined value of a pressure in the fuel accumulator, and
performing closed-loop or open-loop control of a rotational speed of the electric pump as a function of the predefined value of the pressure in the fuel accumulator.

9. The method of claim 8, comprising:
determining an actual pressure in the fuel accumulator,
determining a difference between the determined actual pressure and the predefined value for the pressure, and
regulating the rotational speed of the electric pump as a function of the determined difference between the determined actual pressure and the predefined value for the pressure.

10. The method of claim 8, comprising:
determining a current value for the electric pump as a function of the predefined pressure,
applying the determined current value to the electric pump to control the rotational speed of the electric pump.

11. The method of claim 8, comprising:
determining a value of the electrical current at the electric pump,
determining a value of the electrical voltage at the electric pump,
determining an estimated value for the pressure in the fuel accumulator as a function of the determined value of the current and the determined value of the voltage, and
regulating the rotational speed of the electric pump as a function of the determined estimated value.
